(19) United States
(12) Patent Application Publication
(10) Pub. No.: US 2026/0367900 A1
(43) Pub. Date: Nov. 19, 2026

(54) ITERATIVE SOFTWARE PATCHING

(71) Applicant: INTERNATIONAL BUSINESS MACHINES CORPORATION, ARMONK, NY (US)

(72) Inventors: Kaji Rashad, Mebane, NC (US); Aaditya Bhoota, San Jose, CA (US); Al Chakra, Apex, NC (US)

(21) Appl. No.: 19/207,589

(22) Filed: May 14, 2025

(51) Int. Cl. G06F 8/65

(52) U.S. Cl. CPC G06F 8/65

(57) ABSTRACT

Described are techniques for iterative software patching. The techniques include tracking usage of a function on a plurality of end nodes, ranking the plurality of end nodes based on the usage of the function and characteristics of the plurality of end nodes, and applying a software patch related to the function to a first set of end nodes of the plurality of end nodes. The techniques further include gathering, for a first time, metadata from the first set of end nodes, and, after the first time, applying the software patch to a second set of end nodes of the plurality of end nodes, and gathering, for a second time, metadata from the second set of end nodes. The techniques further include applying the software patch to subsequent sets of end nodes of the plurality of end nodes until all of the plurality of end nodes receive the software patch.

### BACKGROUND

The present disclosure relates to computational systems, and, more specifically, to software patching.

Software patching can refer to the application of code updates to existing software systems. These patches can be designed to resolve known defects, security vulnerabilities, and/or performance limitations and are an essential part of ongoing system maintenance. Software patching continues to grow in importance in response to the increasing frequency and sophistication of cyber threats as well as the evolving complexity of software environments. In addition to fixing software bugs, software patching is a component of risk management and operational resilience. For example, unpatched vulnerabilities remain a leading cause of security breaches, and attackers are often quick to exploit known flaws that organizations have not yet addressed.

### SUMMARY

In some aspects, the techniques described herein relate to a computer-implemented method that comprises tracking usage of a function on a plurality of end nodes. The method further includes ranking the plurality of end nodes based on the usage of the function and characteristics of the plurality of end nodes. The method further includes applying a software patch related to the function to a first set of end nodes of the plurality of end nodes and based on the ranking. The method further includes gathering, for a first time, metadata from the first set of end nodes. The method further includes, after the first time, applying the software patch to a second set of end nodes of the plurality of end nodes and gathering, for a second time, metadata from the second set of end nodes and after the second time. The method further includes applying the software patch to subsequent sets of end nodes of the plurality of end nodes until all of the plurality of end nodes receive the software patch.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment for iterative software patching, in accordance with some embodiments of the present disclosure.

FIG. 2 illustrates a flowchart of an example method for iterative software patching, in accordance with some embodiments of the present disclosure.

FIG. 3 illustrates a flowchart of an example method for downloading, deploying, metering usage, and invoicing use of iterative software patching code, in accordance with some embodiments of the present disclosure.

FIG. 4 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward computational systems, and, more specifically, to software patching. While not limited to such applications, embodiments of the present disclosure may be better understood in light of the aforementioned context.

Modern software patch management can involve more than merely applying updates. Instead, it requires balancing speed with stability such as by testing updates to avoid disruptions, scheduling deployments to minimize downtime and ensuring visibility across endpoints, servers, and cloud platforms. While automation tools have improved software patch deployment, many organizations still face delays due to resource constraints, legacy systems, and/or integration issues. For software patching to be effective, it must be part of a broader, well-managed lifecycle strategy that includes inventory management, vulnerability assessment, and clear policies for prioritization. Software patching plays a vital role in keeping systems secure, compliant, and reliable.

Aspects of the present disclosure relate to techniques for rolling out software updates in a controlled and efficient manner, particularly in large-scale enterprise environments. The problems that are faced currently are the challenge of testing and rolling out updates to thousands of production machines, and the need for a risk-aware update engine that balances the benefits of updates against the risk of outages. To address the above challenge, aspects of the present disclosure involve selecting a node to receive the update based on usage patterns, monitoring the node's behavior, and gradually rolling out the update to more nodes based on a confidence level scheme. Aspects of the present disclosure include three phases: selecting an end node to receive the update, monitoring the node's behavior, and creating a confidence level scheme to gradually roll out the update to additional nodes. The selection process involves ranking nodes based on usage patterns and other metrics, while monitoring involves tracking metrics such as Central Processing Unit (CPU) usage, disk usage, and network usage. The confidence level scheme can include introducing a threshold percentage of total machines that need the update and gradually increasing the number of nodes being tested until the threshold is reached.

Aspects of the present disclosure are thus designed to reduce the risk of outages and ensure that updates are rolled out efficiently. Aspects of the present disclosure are highly relevant to enterprise environments, where software vendors may be held liable for revenue losses caused by faulty software patches. Aspects of the present disclosure are thus especially beneficial for software patch rollouts that are critical for enterprise consumers.

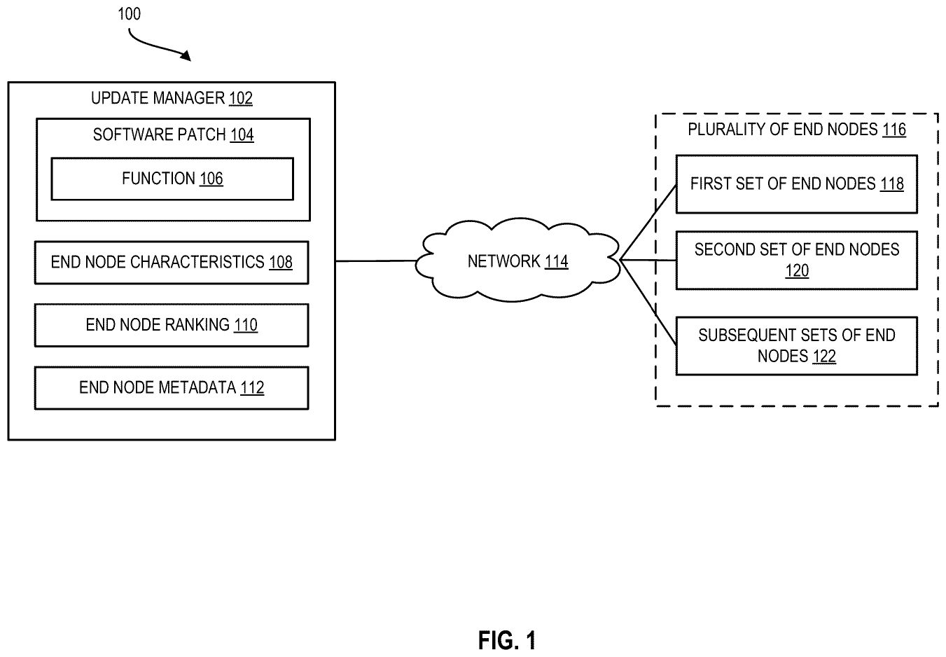

Referring now to the figures, FIG. 1 illustrates a block diagram of an example computational environment 100 for iterative software patching, in accordance with some embodiments of the present disclosure. Computational environment 100 includes an update manager 102 communicatively coupled to a plurality of end nodes 116 via a network 114. Update manager 102 can be a server, desktop, laptop, tablet, mainframe, and/or other combination of hardware and software configured to implement aspects of the present disclosure. The update manager 102 includes a software patch 104 configured to patch a function 106. The update manager 102 further includes end node characteristics 108 of the plurality of end nodes 116 such as, but not limited to, Operating System (OS), OS/Firmware/Middleware/Software version information, hardware information (e.g., CPU, Graphics Processing Unit (GPU), storage, networking, etc.), and the like. Update manager 102 further includes an end node ranking 110 that ranks the plurality of end nodes 116 according to, at least in part, the usage of the function 106 by each of the plurality of end nodes 116. The update manager 102 further includes end node metadata 112 that includes performance data retrieved from the plurality of end nodes 116 before, during, and/or after implementation of the software patch 104.

The plurality of end nodes 116 can include endpoint devices such as servers, mainframes, computers, desktops, laptops, tablets, smartphones, Internet of Things (IoT) devices, and/or other endpoint devices. The plurality of end nodes 116 can include a first set of end nodes 118 configured to receive the software patch 104 in an initial rollout and based on the end node ranking 110. The plurality of end nodes 116 can further include a second set of end nodes 120 configured to receive the software patch 104 in a secondary rollout and based on the end node ranking 110 and end node metadata 112 collected from the first set of end nodes 118. In some embodiments, the second set of end nodes 120 is larger than the first set of end nodes 118 (e.g., twice as large). The plurality of end nodes 116 can further include subsequent sets of end nodes 122 configured to receive the software patch 104 in subsequent rollouts and based on the end node ranking 110 and end node metadata 112 collected from the first set of end nodes 118 and the second set of end nodes 120.

The network 114 can be a single public network (e.g., the Internet) or multiple public or private networks (e.g., Local Area Network (LAN), Wide-Area Network (WAN), etc.) configured to continuously, semi-continuously, or intermittently communicatively couple the update manager 102 to the plurality of end nodes 116.

Update manager 102 can send an update to the plurality of end nodes 116 that introduces a counter tracking a number of times each of the plurality of end nodes 116 calls the function 106 that will be patched by the software patch 104. The update manager 102 can define a first set of end nodes 118 that are a subset of the plurality of end nodes 116 utilizing the function 106 associated with the software patch 104. In some embodiments, the first set of end nodes 118 is based on the type of OS, the amount of compute resources, and/or other factors. The update manager 102 can generate the end node ranking 110 based on metadata received from the counter that tracks the number of times each of the plurality of end nodes 116 calls the function 106 that will be patched by the software patch 104. The end node ranking 110 can be used when selecting the first set of end nodes 118, the second set of end nodes 120, and subsequent sets of end nodes 122.

The update manager 102 can be configured to initially apply the software patch 104 to the first set of end nodes 118, where the first set of end nodes 118 can be a relatively smaller subset of the plurality of end nodes 116 that has a relatively higher usage of the function 106 associated with the software patch 104. Once implemented, the update manager 102 can collect end node metadata 112 from the first set of end nodes 118, where the end node metadata 112 can identify system crashes, abnormal processing usage, abnormal networking usage, and/or abnormal storage usage.

After a predetermined time and satisfactory end node metadata 112, the update manager 102 can be configured to apply the software patch 104 to the second set of end nodes 120, where the second set of end nodes 120 can be relatively lower in the end node ranking 110 than the first set of end nodes 118, and where the second set of end nodes 120 can include relatively more end nodes than the first set of end nodes 118 (e.g., the second set of end nodes 120 can have twice as many end nodes as the first set of end nodes 118). The update manager 102 can collect the end node metadata 112 from the second set of end nodes 120 for a predetermined period of time. Once satisfactory metadata has been collected related to the second set of end nodes 120, the update manager 102 can iteratively apply the software patch 104 to subsequent sets of end nodes 122, where each subsequent set of end nodes 122 has a relatively lower end node ranking 110 and a relatively larger size relative to a previous set of end nodes. The update manager 102 can iteratively apply the software patch 104 to the subsequent sets of end nodes 122 until all of the plurality of end nodes 116 receive the software patch 104.

If at any point in rollout of the software patch 104 the update manager 102 receives end node metadata 112 indicating unexpected, problematic, or otherwise unstable implementation of the software patch 104 at the plurality of end nodes 116, the update manager 102 can pause further rollout of the software patch 104 until such ambiguities are resolved. In this way, aspects of the present disclosure enable a software patch 104 to be strategically rolled out to a small number of power-users of a function 106 associated with the software patch 104 (e.g., the first set of end nodes 118), where the small number of power-users of the function 106 associated with the software patch 104 are most likely to quickly identify problems with the software patch 104 before those problems are universally implemented on the plurality of end nodes 116. Accordingly, aspects of the present disclosure improve software patching performance.

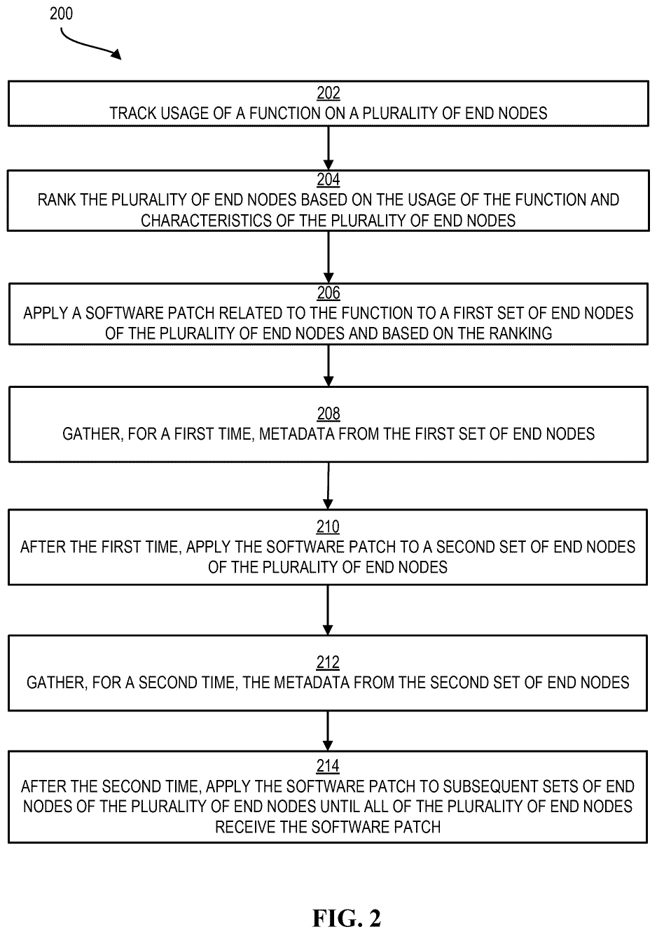

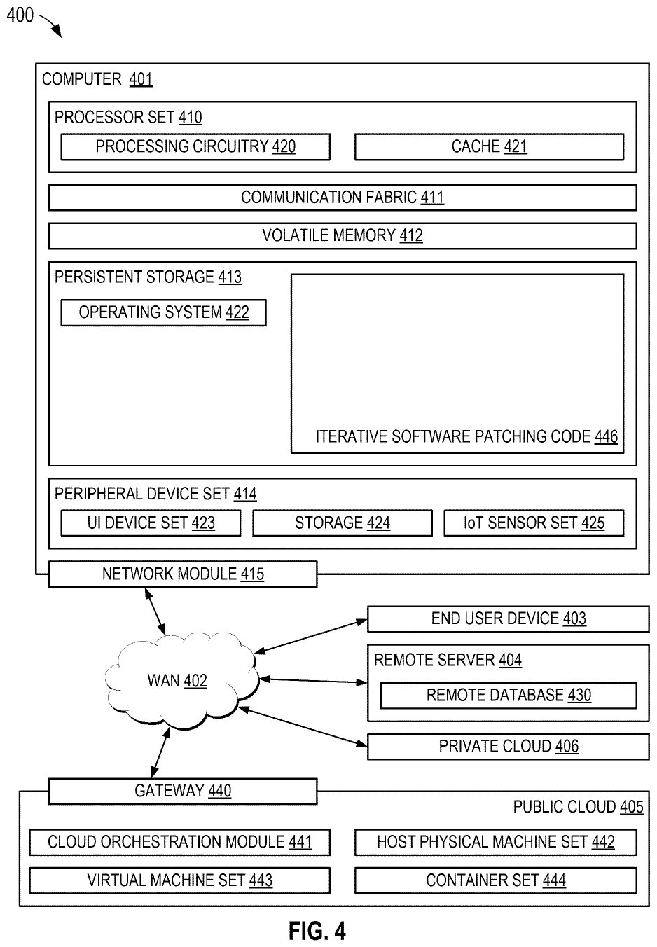

FIG. 2 illustrates a flowchart of an example method 200 for iterative software patching, in accordance with some embodiments of the present disclosure. The method 200 can be implemented by a processor, a computer (e.g., computer 401 of FIG. 4), an update manager (e.g., update manager 102 of FIG. 1), or any other combination of hardware and/or software.

The method 200 initiates at operation 202 where usage of a function 106 on a plurality of end nodes 116 can be tracked. The function 106 can be associated with a software patch 104. In some embodiments, operation 202 tracks usage of the function 106 by updating each of the plurality of end nodes 116 to contain a counter indicating a number of times a respective end node of the plurality of end nodes 116 calls various functions such as function 106 associated with the software patch 104.

In operation 204, the plurality of the end nodes 116 can be ranked based on the usage of the function 106 and/or end node characteristics 108. In some embodiments, the list of the end nodes can be ranked based on usage of the function 106. In some other embodiments, the list of the end nodes can be ranked based on usage of the function 106 and a uniqueness of the device receiving the software patch 104 as indicated by the end node characteristics 108 (e.g., OS, CPU, Random Access Memory (RAM), Direct Access Storage Device (DASD), etc.). In some embodiments, the end node ranking 110 can be a subset of the plurality of end nodes 116 that is representative of all device characteristics in an entire customer base.

In operation 206, the software patch 104 can be applied to a first set of end nodes 118 based on the end node ranking 110 in an initial rollout. The end node ranking 110 can be based on metadata received from the counter that tracks the number of times each of the plurality of end nodes 116 calls the function 106 that will be patched by the software patch 104.

In operation 208, metadata from the first set of end nodes 118 can be gathered for a first time. In some embodiments, the metadata can include information related to, for example, CPU usage above a threshold, CPU variability above a threshold, network usage above a threshold, network variability above a threshold, storage usage above a threshold, storage variability above a threshold, I/O usage above a threshold, I/O variability above a threshold, and end node crashes, errors, and/or other failures. End node metadata 112 can thus identify system crashes, abnormal processing usage, abnormal networking usage, and/or abnormal storage usage.

Although not explicitly shown, if during the first time the metadata indicates that the software patch 104 causes unexpected performance issues in the first set of end nodes 118, the rollout of the software patch 104 can be paused, the software patch 104 can be modified, and the modified software patch 104 can be re-installed on the first set of end nodes 118 (e.g., by returning to operation 206).

Operation 210 illustrates that after the first time, the software patch 104 is applied to a second set of end nodes 120 of the plurality of end nodes 116. In some embodiments, the second set of end nodes 120 is larger than the first set of end nodes 118. For example, the second set of end nodes 120 can be twice as large as the first set of end nodes 118. In some embodiments, there is a predetermined delay period (e.g., one day) after the first time and prior to initiating operation 210.

In operation 212 the end node metadata 112 from the second set of end nodes 120 is gathered for a second time. In some embodiments, the first set of end nodes 118 is monitored and observed for a longer duration, whereas the second set of end nodes 120 is monitored and observed for a lesser duration. As one example, the second time can be half as long as the first time.

Although not explicitly shown, if during the second time the metadata indicates that the software patch 104 causes unexpected performance issues in the first set of end nodes 118 and/or the second set of end nodes 120, the rollout of the software patch 104 can be paused, the software patch 104 can be modified, and the modified software patch 104 can be re-installed on the first set of end nodes 118 and/or the second set of end nodes 120 (e.g., by returning to operation 206).

In operation 214, after the second time, the software patch 104 is applied to subsequent sets of end nodes 122 of the plurality of end nodes 116 until all the plurality of end nodes 116 receive the software patch 104. In some embodiments, there is a predetermined delay period after the second time and prior to applying the software patch 104 to the subsequent sets of end nodes 122. In some embodiments, each subsequent set of end nodes has a relatively lower end node ranking 110 and a relatively larger set size relative to a previous set of end nodes (e.g., twice as large as the previous set of end nodes). Additionally, in some embodiments, each subsequent set of end nodes is separated by relatively shorter intervals of observation. In this way, aspects of the present disclosure can iteratively accelerate the rollout of the software patch 104 as confidence increases that the software patch 104 is effective and without unintended drawbacks by increasing subsequent sizes of the sets of end nodes while reducing subsequent intervals separating the subsequent sets of end nodes 122.

Although not explicitly shown, if during any of the subsequent time intervals the metadata indicates that the software patch 104 causes unexpected performance issues in any of the subsequent sets of end nodes 122, the rollout of the software patch 104 can be paused, the software patch 104 can be modified, and the modified software patch 104 can be re-installed on the first set of end nodes 118, the second set of end nodes 120, and/or the subsequent sets of end nodes 122 (e.g., by returning to operation 206).

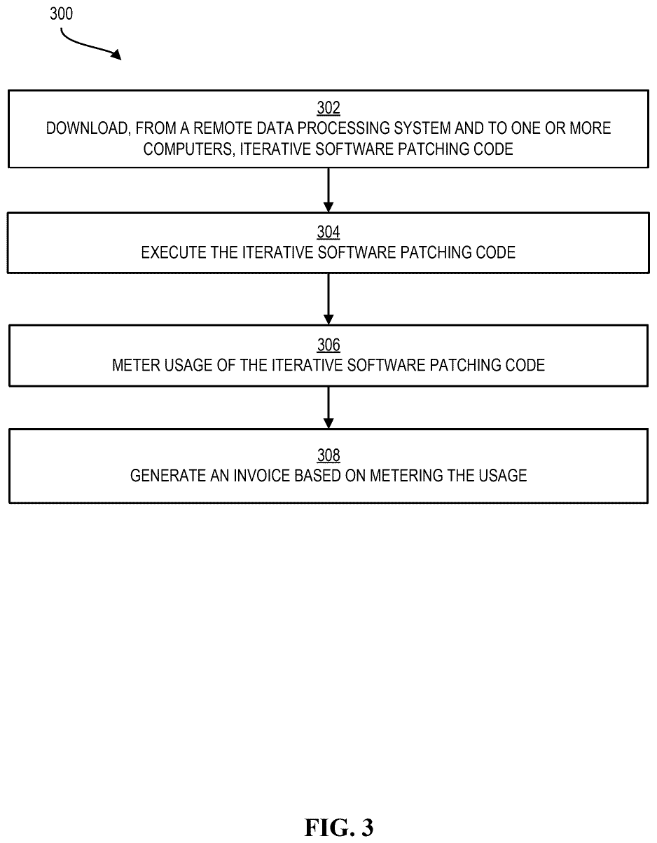

FIG. 3 illustrates a flowchart of an example method 300 for downloading, deploying, metering usage, and invoicing use of iterative software patching code 446, in accordance with some embodiments of the present disclosure. The method 300 can be implemented by a processor, a computer (e.g., computer 401 of FIG. 4), an update manager (e.g., update manager 102 of FIG. 1), or any other combination of hardware and/or software. In some embodiments, the method 300 occurs before, during, and/or after any of the aforementioned methods.

Operation 302 includes downloading, from a remote data processing system and to one or more computers (e.g., update manager 102 of FIG. 1, computer 401 of FIG. 4, etc.) iterative software patching code 446. Operation 304 includes executing the iterative software patching code 446. The executing can include performing any of the methods and/or functionalities discussed herein. Operation 306 includes metering usage of the iterative software patching code 446. Usage can be metered by, for example, an amount of time the iterative software patching code 446 is used, a number of servers and/or devices deploying the iterative software patching code 446, an amount of resources consumed by implementing the iterative software patching code 446, a number of end nodes receiving a software patch by execution of the iterative software patching code 446, and the like. Operation 308 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 4 illustrates a block diagram of an example computing environment, in accordance with some embodiments of the present disclosure. Computing environment 400 contains an example of an environment for the execution of at least some of the computer code involved in performing the inventive methods, such as Iterative software patching code 446. In addition to Iterative software patching code 446, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and Iterative software patching code 446, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in Iterative software patching code 446 in persistent storage 413.

Communication fabric 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface type operating systems that employ a kernel. The code included in Iterative software patching code 446 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

Cloud computing services and/or microservices (not separately shown in FIG. 4): private clouds 406 and public clouds 405 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present disclosure can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

Following is a set of example clauses related to aspects of the present disclosure. Clause 1. A computer-implemented method comprising: tracking usage of a function on a plurality of end nodes; ranking the plurality of end nodes based on the usage of the function and characteristics of the plurality of end nodes; applying a software patch related to the function to a first set of end nodes of the plurality of end nodes and based on the ranking; gathering, for a first time, metadata from the first set of end nodes; after the first time, applying the software patch to a second set of end nodes of the plurality of end nodes; gathering, for a second time, metadata from the second set of end nodes; and after the second time, applying the software patch to subsequent sets of end nodes of the plurality of end nodes until all of the plurality of end nodes receive the software patch.

Clause 2. The computer-implemented method of clause 1, wherein the metadata comprises end node crashes, Central Processing Unit (CPU) usage above a CPU threshold, network usage above a network threshold, storage usage above a storage threshold, and Input/Output (I/O) usage above an I/O threshold.

Clause 3. The computer-implemented method of clause 1, wherein the second time is shorter than the first time.

Clause 4. The computer-implemented method of clause 1, wherein after the first time and after the second time is a predefined delay period.

Clause 5. The computer-implemented method of clause 1, wherein the second set of end nodes is ranked lower than the first set of end nodes in the ranking.

Clause 6. The computer-implemented method of clause 1, wherein the second set of end nodes is larger than the first set of end nodes.

Clause 7. The computer-implemented method of clause 1, wherein the first set of end nodes is ranked highest in the ranking.

Clause 8. The computer-implemented method of clause 1, wherein the computer-implemented method is executed by a computational system based on code downloaded to the computational system from a remote data processing system, and wherein the computer-implemented method further comprises: metering usage of the code; and generating an invoice based on metering the usage of the code.

Clause 9. A system comprising: one or more processors; and one or more computer readable storage media storing program instructions which, when executed by the one or more processors, are configured to cause the one or more processors to perform a method comprising: tracking usage of a function on a plurality of end nodes; ranking the plurality of end nodes based on the usage of the function and characteristics of the plurality of end nodes; applying a software patch related to the function to a first set of end nodes of the plurality of end nodes and based on the ranking; gathering, for a first time, metadata from the first set of end nodes; after the first time, applying the software patch to a second set of end nodes of the plurality of end nodes; gathering, for a second time, metadata from the second set of end nodes; and after the second time, applying the software patch to subsequent sets of end nodes of the plurality of end nodes until all of the plurality of end nodes receive the software patch.

Clause 10. The system of clause 9, wherein the second time is shorter than the first time.

Clause 11. The system of clause 9, wherein after the first time and after the second time is a predefined delay period.

Clause 12. The system of clause 9, wherein the second set of end nodes is ranked lower than the first set of end nodes in the ranking.

Clause 13. The system of clause 9, wherein the second set of end nodes is larger than the first set of end nodes.

Clause 14. The system of clause 9, wherein the first set of end nodes is ranked highest in the ranking.

Clause 15. A computer program product comprising one or more computer readable storage media, and program instructions collectively stored on the one or more computer readable storage media, the program instructions comprising instructions configured to cause one or more processors to perform a method comprising: tracking usage of a function on a plurality of end nodes; ranking the plurality of end nodes based on the usage of the function and characteristics of the plurality of end nodes; applying a software patch related to the function to a first set of end nodes of the plurality of end nodes and based on the ranking; gathering, for a first time, metadata from the first set of end nodes; after the first time, applying the software patch to a second set of end nodes of the plurality of end nodes; gathering, for a second time, metadata from the second set of end nodes; and after the second time, applying the software patch to subsequent sets of end nodes of the plurality of end nodes until all of the plurality of end nodes receive the software patch.

Clause 16. The computer program product of clause 15, wherein the second time is shorter than the first time.

Clause 17. The computer program product of clause 15, wherein after the first time and after the second time is a predefined delay period.

Clause 18. The computer program product of clause 15, wherein the second set of end nodes is ranked lower than the first set of end nodes in the ranking.

Clause 19. The computer program product of clause 15, wherein the second set of end nodes is larger than the first set of end nodes.

Clause 20. The computer program product of clause 15, wherein the first set of end nodes is ranked highest in the ranking.

What is claimed is:

1. A computer-implemented method comprising:
tracking usage of a function on a plurality of end nodes;
ranking the plurality of end nodes based on the usage of the function and characteristics of the plurality of end nodes;
applying a software patch related to the function to a first set of end nodes of the plurality of end nodes and based on the ranking;
gathering, for a first time, metadata from the first set of end nodes;
after the first time, applying the software patch to a second set of end nodes of the plurality of end nodes;
gathering, for a second time, metadata from the second set of end nodes; and
after the second time, applying the software patch to subsequent sets of end nodes of the plurality of end nodes until all of the plurality of end nodes receive the software patch.

2. The computer-implemented method of claim 1, wherein the metadata comprises end node crashes, Central Processing Unit (CPU) usage above a CPU threshold, network usage above a network threshold, storage usage above a storage threshold, and Input/Output (I/O) usage above an I/O threshold.

3. The computer-implemented method of claim 1, wherein the second time is shorter than the first time.

4. The computer-implemented method of claim 1, wherein after the first time and after the second time is a predefined delay period.

5. The computer-implemented method of claim 1, wherein the second set of end nodes is ranked lower than the first set of end nodes in the ranking.

6. The computer-implemented method of claim 1, wherein the second set of end nodes is larger than the first set of end nodes.

7. The computer-implemented method of claim 1, wherein the first set of end nodes is ranked highest in the ranking.

8. The computer-implemented method of claim 1, wherein the computer-implemented method is executed by a computational system based on code downloaded to the computational system from a remote data processing system, and wherein the computer-implemented method further comprises:
metering usage of the code; and
generating an invoice based on metering the usage of the code.

9. A system comprising:
one or more processors; and
one or more computer readable storage media storing program instructions which, when executed by the one or more processors, are configured to cause the one or more processors to perform a method comprising:
tracking usage of a function on a plurality of end nodes;
ranking the plurality of end nodes based on the usage of the function and characteristics of the plurality of end nodes;
applying a software patch related to the function to a first set of end nodes of the plurality of end nodes and based on the ranking;
gathering, for a first time, metadata from the first set of end nodes;
after the first time, applying the software patch to a second set of end nodes of the plurality of end nodes;
gathering, for a second time, metadata from the second set of end nodes; and
after the second time, applying the software patch to subsequent sets of end nodes of the plurality of end nodes until all of the plurality of end nodes receive the software patch.

10. The system of claim 9, wherein the second time is shorter than the first time.

11. The system of claim 9, wherein after the first time and after the second time is a predefined delay period.

12. The system of claim 9, wherein the second set of end nodes is ranked lower than the first set of end nodes in the ranking.

13. The system of claim 9, wherein the second set of end nodes is larger than the first set of end nodes.

14. The system of claim 9, wherein the first set of end nodes is ranked highest in the ranking.

15. A computer program product comprising one or more computer readable storage media, and program instructions collectively stored on the one or more computer readable storage media, the program instructions comprising instructions configured to cause one or more processors to perform a method comprising:
tracking usage of a function on a plurality of end nodes;
ranking the plurality of end nodes based on the usage of the function and characteristics of the plurality of end nodes;
applying a software patch related to the function to a first set of end nodes of the plurality of end nodes and based on the ranking;
gathering, for a first time, metadata from the first set of end nodes;
after the first time, applying the software patch to a second set of end nodes of the plurality of end nodes;
gathering, for a second time, metadata from the second set of end nodes; and
after the second time, applying the software patch to subsequent sets of end nodes of the plurality of end nodes until all of the plurality of end nodes receive the software patch.

16. The computer program product of claim 15, wherein the second time is shorter than the first time.

17. The computer program product of claim 15, wherein after the first time and after the second time is a predefined delay period.

18. The computer program product of claim 15, wherein the second set of end nodes is ranked lower than the first set of end nodes in the ranking.

19. The computer program product of claim 15, wherein the second set of end nodes is larger than the first set of end nodes.

20. The computer program product of claim 15, wherein the first set of end nodes is ranked highest in the ranking.
